(19) United States
(12) Patent Application Publication
(10) Pub. No.: US 2009/0240434 A1
(43) Pub. Date: Sep. 24, 2009

(54) Lightning detection

(75) Inventors: Jakke Sakari Makela, Turku (FI); Niko Santeri Porjo, Piikkio (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/077,949

(22) Filed: Mar. 20, 2008

(51) Int. Cl. G01W 1/00

(52) U.S. Cl. 702/4

(57) ABSTRACT

This disclosure relates to a method, a computer program product, a device, and a system for detecting direction information of at least one pulse of at least one received signal, downconverting the at least one received signal, and performing lightning detection based on the at least one detected pulse direction information and the at least one downconverted signal.

### FIELD OF THE APPLICATION

This invention relates to a method, a computer program product, a device, and a system for lightning detection.

### BACKGROUND OF THE APPLICATION

Thunderstroms are a major weather hazard, but are difficult to predict. Thunderstorms come along with lightning strokes, which are generated by an electrical discharge from a cloud to the ground.

One approach to perform lightning detection is based on mixing down the lightning signal received from an antenna to lower frequencies. As the mixer local oscillator phase is unknown, information of the direction of magnetic field (or its derivative) in the antenna is lost. In practice it becomes impossible, even with several antennas to know in which quadrant of the coordinate system the signal emanated from. This does not have an effect on the distance measurement functionality but makes it impossible to find the actual place of the lightning source. For instance, depending on the unknown of the mixer local oscillator phase, a pulse received from the antenna may be mixed with a positive value of the local oscillating signal of the mixer or with a negative value of the local oscillating signal. Thus, without knowledge of the local oscillator phase, the information of the direction of the electric current in the antenna is lost.

Furthermore, there is both positive and negative cloud ground lightning. As the direction of current is different in these cases, direction of the magnetic field in the antenna also changes and the position of a single stroke again becomes ambiguous.

### SUMMARY

According to a first aspect of the present invention, a method is described, comprising detecting direction information of at least one pulse of at least one received signal, downconverting the at least one received signal, performing lightning detection based on the at least one detected pulse direction information and the at least one downconverted signal.

According to a second aspect of the present invention, a device is described, comprising at least one detector configured to detect direction information of at least one pulse of at least one received signal, at least one mixer configured to downconvert the at least one received signal, and a processor configured to perform lightning detection based on the at least one pulse direction information and the at least one downconverted signal.

According to a third aspect to the present invention, a system is described, said system comprising at least one antenna configured to receive at least one signal, a device as described above, and a display configured to display a detected lightning.

According to a fourth aspect of the present invention, a computer-readable storage medium encoded with instructions is described, that, when executed by a computer, perform: detecting direction information of at least one pulse of at least one received signal, downconverting the at least one received signal, performing lightning detection based on the at least one detected pulse direction information and the at least one downconverted signal.

According to a fifth aspect of the present invention, a computer readable medium having a computer program stored thereon is described, the computer program for execution on a computer for carrying out a method comprising detecting direction information of at least one pulse of at least one received signal, downconverting the at least one received signal, performing lightning detection based on the at least one detected pulse direction information and the at least one downconverted signal.

According to a sixth aspect of the present invention, a device means is described, the device means comprising at least one detecting means for detecting direction information of at least one pulse of at least one received signal, at least one mixing means for downconverting the at least one received signal, a processor means for performing lightning detection based on the at least one detected pulse direction information and the at least one downconverted signal.

According to a seventh aspect of the present invention, an information providing method is described, comprising detecting direction information of at least one pulse of at least one received signal, downconverting the at least one received signal, performing lightning detection based on the at least one detected pulse direction information and the at least one downconverted signal.

According to an eighth aspect of the present invention, an information providing apparatus is described, comprising at least one detecting means for detecting direction information of at least one pulse of at least one received signal, at least one mixing means for downconverting the at least one received signal, a processor means for performing lightning detection based on the at least one detected pulse direction information and the at least one downconverted signal.

The described device or apparatus may comprise at least one detector configured to detect direction information of a pulse of at least one received signal. This at least one received signal may be received via at least one antenna. The device or apparatus may further comprise at least one mixer configured to downconvert the at least one received signal and a processor configured to perform lightning detection based on the at least one detected pulse direction information and the at least one downconverted signal.

For instance, the at least one antenna may represent a coil antenna, but also any other suited antenna may be used. Furthermore, the at least one antenna may have a spatial directivity, and for instance, the antenna may have a differential output. For example, the at least one antenna may be part of a resonance circuit.

The received signal from at least one antenna is used by the at least one detector in order to detect direction information of at least one pulse of the received signal. The direction of the pulse may be considered to represent the direction of the pulse's current flowing through the respective antenna. Thus, the detected pulse direction information may be considered to represent the information of the direction of the magnetic field (or its derivative) in the respective antenna associated with the detector.

A pulse in a received signal may be caused by an electrical discharge within a cloud or by a cloud to ground lightning, for instance.

The detection of pulse direction information may be performed in different ways. For instance, a gradient detection method may be used in order detect whether a pulse starts with a positive slope or a negative slope. For example, this may be realized based on differentiating the received signal. The pulse direction information may for instance represent the direct information about the direction of the detected pulse, or it may contain information which is suited to determine the direction of the detected pulse. For instance, this calculation may be performed by the processor or by the detector itself.

Or, for instance, the detection pulse direction may be performed based on peak detection. For example, the detecting the direction information of a pulse may comprise detecting whether a pulse of the received signal exceeds a positive threshold level or exceeds a negative threshold level, and depending on the trigger events the pulse direction can be determined.

Of course, any other well-suited method may be performed to carry out the pulse direction information detection of a pulse of one of the at least one received signals by a detector of said at least one detector.

Furthermore, each of the at least one received signal may be fed to one mixer, wherein the mixer is configured to downconvert the received signal into lower frequency ranges. For instance, each of the at least one mixer may be fed with a local oscillating signal having a predetermined oscillating frequency.

For example, each of the mixer may be configured to mix the received signal down to audio frequencies. Thus, the processor, which is configured to process the at least one downconverted received signal, can operate at a low clock rate so that a low power consumption and a reasonable price may be achieved.

The lightning detection is based on the downconverted received signal and the detected pulse direction information. Based on the detected pulse direction information, the direction of the lightning source with respect to the characteristics of the respective antenna can be determined. Thus, due to the detected pulse direction the information of the direction of the magnetic field in the respective antenna is known and can be used to determine the direction of a lightning event.

Thus, the phase of the local oscillating signal of a mixer associated with a received signal is not necessary in order to determine the direction of current of a pulse of the received signal, since the pulse direction is detected by means of pulse direction information of the respective detector before the received signal is downconverted by the mixer. Accordingly, the phase information of any of the local oscillating signals is not necessary. Hence, tracking the phase of the local oscillating signal is not necessary.

For instance, based on the detected pulse direction, the detected lightning can be placed in the correct part of a coordinate system. For instance, an antenna may have two directional lobes, wherein these two lobes may have opposite directions to each other. Thus, based on the detected pulse direction, it can be determined from which lobe of these two lobes of the antenna the lightning emanates from. Accordingly, the direction of the lightning can be detected.

Furthermore, for instance, it may be assumed that negative cloud to ground lightning is more frequent than positive cloud to ground lightning, as described in Rakov, V. and M. Uman, “Lightning: Physics and Applications”, Cambridge University Press, 2004, Chapter 5. This information may be combined with the pulse direction information from any of the at least one detector, so that ambiguity of the direction of the lightning source can be removed.

Further, information about the pulse may be extracted from the respective donwconverted received signal in order to separate pulses generated from positive cloud to ground lightning and pulses generated from negative cloud to ground lightning. Based on this separation and the detected pulse direction, the direction of the lightning can be determined and the position of the lightning source can be determined.

Furthermore, for instance, the at least one downconverted received signal may be used to determine the distance of the lightning with respect to the antenna. For instance, an average lightning signal may be assumed to have 1/f dependence between amplitude and frequency. Processing of the gathered signals may be done based on the distribution of activity. For instance, the distance may be determined based on the amplitude and frequency of the lightning signal.

Thus, the processor may be configured to determine the direction and the distance of the lighting based on the detected pulse direction and the downconverted received signal.

The processor may comprise a computer processor, application-specific integrated circuit (ASIC), field-programmable gate array (FPGA), one or more memories (e.g, ROM, CD-ROM, etc.) and/or other hardware components that have been programmed in such a way to carry out the inventive function.

For instance, each of said at least one detector may be associated with one mixer of said at least one mixer, thereby defining a signal path. Each of this at least one signal path may be associated with a separate antenna.

The lightning detection may for instance be used in mobile devices, like a mobile phone or a handheld computer or any other mobile device. Due to mixing the received signal down to lower frequencies power consumption of the processor can be reduced, and the detection of the direction information of the pulse allows determining the pulse direction and thus the direction of the lightning event.

According to an embodiment of the present invention, the detecting of the direction information of at least one pulse of at least one received signal is based on a signal peak detection.

According to an embodiment of the present invention, detecting the direction information of at least one pulse comprises at least one of: detecting whether the received signal is higher than a positive threshold level, and detecting whether the received signal is less than a negative threshold level.

Thus, each of the at least one detector may comprise a threshold detector which is configured to detect whether the received signal exceeds at least one out of the positive threshold level and the negative threshold level.

For instance, in case a received signal first exceeds the positive threshold, the pulse direction may be detected to be positive, and, in the other case, i.e. the received pulse first fall below the negative threshold, the pulse direction may be detected to be negative. The absolute values of the positive threshold level and the negative threshold level may be different or may have the same value. This detected pulse information may be fed from the respective detector to the processor.

Furthermore, for instance, the peak detection may be performed by each of the at least one detector in the way that time stamps or other trigger representatives are generated in case the positive and/or the negative thresholds level is exceeded by the received signal. For instance, said representatives of said trigger events may be coded signals indicating the respecting trigger event. Thus, based on these timestamps or the trigger representatives, which represent pulse direction information, and the associated positive or negative threshold, the processor can determine the pulse direction of a pulse of the respective received signal.

The threshold levels of any of the at least one detector may be variable, and thus any of the detectors may be configurable in order to adjust the threshold levels.

According to an embodiment of the present invention, at least one of said threshold levels is adjusted based on the at least one downconverted received signal.

Thus, signal statistics of the at least one downconverted received signal may be used to adjust the threshold levels of the at least one detector.

According to an embodiment of the present invention, said lightning detection is triggered when said at least one pulse of the at least one received signal is detected.

For instance, the processor is configured to be switched on and off, and each of the at least one detector is configured to switch on the processor after a pulse of at least one received signal is detected.

Thus, each of the at least one detector may be used to wake up parts of the device in case a pulse of a lightning is detected. If no pulse is detected for a predetermined time period, those parts may be switched off in order to save power.

According to an embodiment of the present invention, low-pass filtering and analog-to-digital converting of each of the at least one downconverted signal is performed.

For instance, each of said at least one mixer is associated with a low-pass filter and an analog-to-digital converter configured to perform low-pass filtering and analog-to digital conversion of the respective downconverted received signal.

Thus, the filter may fulfill the nyquist criterion with respect to the sampling rate of the analog-to-digital converter. Hence, signals above the nyquist frequency can be removed.

According to an embodiment of the present invention, said low-pass filtering has a cut-off frequency which is substantially higher than the nyquist frequency associated with the analog-to-digital converting.

Furthermore, for instance, as another example, each of the low-pass filters may represent a low-pass filter having a wider frequency range than the nyquist frequency. Thus, also energy of higher frequencies can be used for lightning detection in order to measure the distance, since measuring the distance may likely concentrate on activity and not on specific signal shape. Further, letting higher frequencies alias makes the signal stronger. Thus, this embodiment may be used to reduce the bandwidth in the digital part, whereby the overall system performance, e.g. smaller power consumption and complexity, may be increased.

For instance, the cut-off frequency of the low-pass filter may be in the range between twice to ten times of the nyquist frequency, but the cut-off frequency may even be higher than ten times the nyquist frequency.

Hence, a narrowband receiver can be used for lightning detecting, wherein this narrowband receiver may operate at a single frequency.

According to an embodiment of the present invention, said at least one received signal comprises at least two received signals, and wherein each of said at least two received signals is associated with a different antenna.

Thus, at least two signal paths are used for lightning detection, wherein each signal path is associated with one of said at least two received signals and with a different antenna.

The at least two antennas may represent at least two physical orthogonal antennas, or may represent at least two substantially orthogonal antennas, or may represent at least two antennas having different spatial directivity.

For instance, the lobes of the different antennas may be chosen that the sum of the lobes of all antennas covers a 360° degree range. Thus, the complete surrounding field can be detected for lightning. For instance, the lobes of the different signal paths may have overlapping directions.

According to an embodiment of the present invention, each of said at least two received signals is associated with a separate oscillating signal and said downconverting comprises mixing each of the at least two received signals with the associated oscillating signal, wherein each of said at least two oscillating signals has a different phase.

Thus, the device may comprise at least two mixers, wherein each of said at least two received signals is associated with one mixer of said at least two mixers, and wherein each of said at least two mixers is associated with a separate oscillating signal in order to downconvert the respective received signal, and wherein each of said at least two oscillating signals has a different phase.

For instance, a first mixer of a first signal path is provided with a first local oscillating signal and a second mixer of a second signal path is provided with a second local oscillating signal. Both first and second local oscillating signals may have the same oscillating frequencies, but may have different phases. For instance, the phases of the first and second local oscillating signals may be orthogonal or at least substantially orthogonal.

Lightning signals with significant amplitude may exist up to several giga hertz. Due to the different phases of the local oscillating signals it may be possible to detect even very short lightning bursts having high frequencies, wherein these bursts may ride on the top of a lower frequency lightning signal. For instance, when theses bursts occur at a time when the absolute value of the first local oscillating signal waveform is small they can be lost in the first signal path, but due to phase shifted second local oscillating signal the absolute value of the second local oscillating signal is higher and these bursts can be processed via the second signal path and the processor. Thus, even transients can be detected reliably due to the different phases of the local oscillating signals of the first and second mixers.

For instance, a single local oscillator may be used to generate the oscillating signals, wherein the first mixer may be directly fed with the local oscillating signal generated by the local oscillator, and wherein at least one phase shifter is added in order to feed the at least one further mixer with phase shifted oscillating signals.

Thus, when the antennas of the different signal paths have overlapping directions, indication of these short bursts can be determined from at least one of the different signal paths. Hence, a subset of lightning phenomena emit Radio Frequency (RF) radiation in short bursts can be used for lightning detection.

According to an embodiment of the present invention, said lightning detection comprises detecting the direction of a lightning event based on the at least one detected pulse direction information.

For instance, based on the detected pulse direction information, and thus based on the detected pulse direction, the detected lightning can be placed in the correct part of a coordinate system. For instance, an antenna may have two directional lobes, whereby for instance the first lobe may cover a spatial range from 0° to 180° and the second lobe may cover a spatial range from 180° to 360°. Based on the detected pulse direction, it can be determined whether the lightning signal emanates from the spatial range from 0° to 180° associated with the first lobe or from the spatial range from 180° to 360° associated with the second lobe. Thus, the direction of the lightning can be detected. According to an embodiment of the present invention, each of said at least one received signal is associated with a different antenna, each of this at least one antenna having a directional axis and a first lobe extending to one side of the directional axis and a second lobe extending to an opposite side of the directional axis, and wherein the detected pulse direction information associated with the received signal from one of said at least one antenna indicates whether the signal is received from the first lobe or the second lobe of this antenna.

It has to be understood that both the first lobe and the second lobe may comprise several sub-lobes.

For instance, in case two antennas are used, the directional axes may span a Cartesian coordinate system, and the detected pulse direction information can be used to place the detected lightning source in the correct quadrant of the coordinate system.

Furthermore, for instance, three or more antennas may be used, wherein the directional axes may span a three dimensional coordinate system. In this case, there are 8 parts in the coordinate system which the ambiguity exists, and wherein the detected pulse direction information can be used to remove this ambiguity.

Thus, for any of the at least one directional axis the associated detected pulse detection information can be used to remove the direction ambiguity, i.e. to determine from which direction of the axis the detected lightning has emanated from. Accordingly, this direction information can be used to remove position ambiguity in any kind of coordinate system, wherein this coordinate system may only have one axis, or two axes, or more axes, which may depend on the number of input signal paths and antennas.

According to an embodiment of the present invention, said detecting the direction of a lightning source, as in storm, based on the at least one detected pulse direction information is performed based on statistical information that positive cloud to ground lightning is less frequent than negative cloud to ground lightning.

Furthermore, for instance, it may be assumed that negative cloud to ground lightning is more frequent than positive cloud to ground lightning. This information may be combined with the pulse direction information from any of the at least one detector, so that ambiguity of the direction of the lightning source can be removed.

Further, statistical information about the pulse may be extracted from the respective downconverted received signal in order to separate pulses generated from positive cloud to ground lightning and pulses generated from negative cloud to ground lightning. For instance, based on this separation and the detected pulse direction, the direction of the lightning can be determined and the position of the lightning source can be determined.

According to an embodiment of the present invention, said lightning detection comprises measuring the distance of a lightning event based on the at least one downconverted received signal.

It may be assumed that each of said at least one received signal is associated with an own input signal path with a separate antenna, as mentioned above.

Each of the downconverted received signal may be used to determine the distance of the lightning with respect to the antenna of the signal path associated with this received signal. For instance, an average lightning signal may be assumed to have 1/f dependence between amplitude and frequency. Processing of the downconverted signal may be done based on the distribution of activity. For instance, the distance associated with a received signal may be determined based on the amplitude and frequency of the lightning signal.

In case two input signals paths are applied, wherein the antennas may be substantially orthogonal to each other, the first measured distance may represent an absolute distance value on the x-axis of a coordinate system, and the second measured distance may represent an absolute value on the y-axis of the coordinate system. Together with the pulse direction information associated with the first and second input signal, respectively, the leading sign of the respective absolute value can be obtained from the detected pulse direction of the respective signal path.

Thus, in this example with two input signal paths, the correct quadrant of the coordinate system can be determined by means of the detected pulse directions, and the angle of the lightning event in this quadrant can be obtained from the two downconverted signals.

Strict orthogonality between the input signal paths is not required. Furthermore, more than two input signal paths may be used. For instance, the use of three input signal paths may make the detection independent of orientation of the host device on the condition that the orientation is known. For instance, the orientation can be known if the host device has an accelerometer that can give this information.

According to an embodiment of the present invention, each of said at least one received signal is associated with a different antenna, each of this at least one antenna having a directional axis, wherein said measuring the distance of a lightning event comprises determining the distance in at least one directional axis of the at least one antenna, wherein the distance in an directional axis of an antenna is determined based on the frequency and amplitude of the downconverted received signal which is associated with this antenna.

For instance, the distance d in a directional axis of an antenna may be determined by means of the following equation:

$$d = k \frac{A}{f} ,$$

wherein A represents the amplitude of the respective downconverted received signal, f represents the frequency of the downconverted signal and k represent a constant factor.

For instance, the distances for several tuples of amplitudes A and frequencies f may be stored in a look-table. Thus, the equation for determining the distance may be solved without performing further calculations.

These and other aspects of the invention will be apparent from and elucidated with reference to the embodiments described hereinafter.

### BRIEF DESCRIPTION OF THE FIGURES

In the figures show:

FIG. 1a: a schematic block diagram of a first exemplary embodiment of a device according to the present invention;

FIG. 1b: a schematic diagram of an exemplary pulse to be detected;

FIG. 2a: a schematic flowchart of an exemplary embodiment of a method according to the present invention;

FIG. 2b: a schematic block diagram of a second exemplary embodiment of a device according to the present invention;

FIG. 3a: a schematic block diagram of a third exemplary embodiment of a device according to the present invention;

FIG. 3b: a schematic block diagram of a fourth exemplary embodiment of a device according to the present invention;

FIG. 4: schematic direction patterns of two antennas; and

FIG. 5: a schematic mirror image of a storm based on detected lightnings.

### DETAILED DESCRIPTION

In the following detailed description, exemplary embodiments will be described.

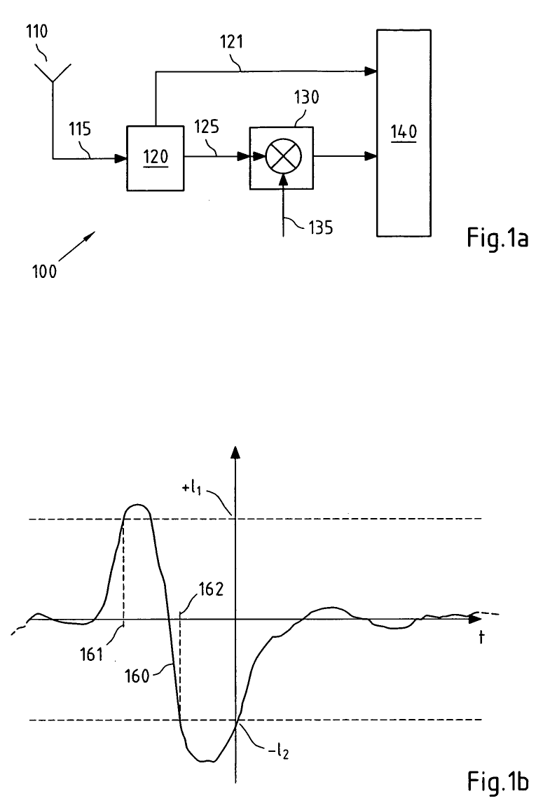

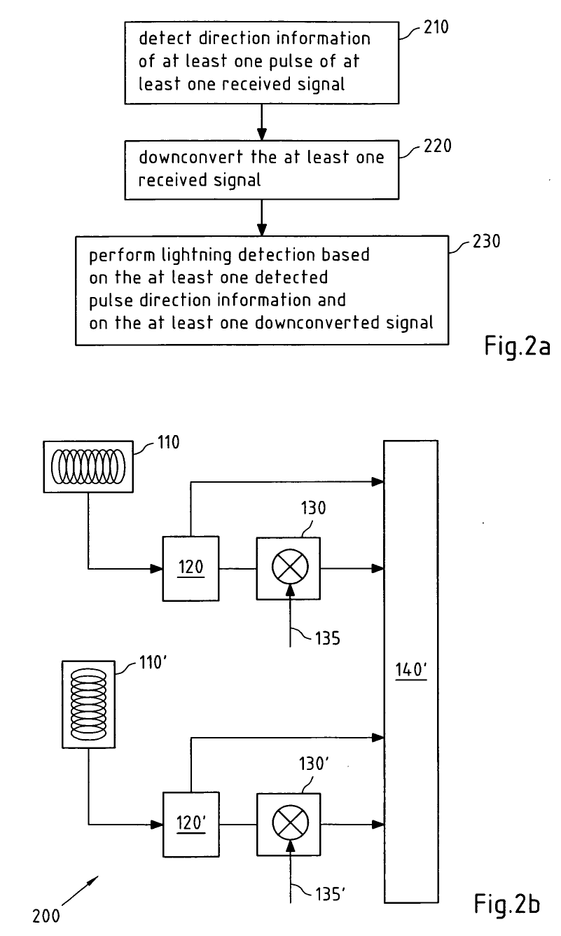

FIG. 1a depicts a schematic block diagram of a first exemplary embodiment of a device 100. This device 100 will be described in combination with the schematic flowchart of an exemplary embodiment of a method according to the present invention depicted in FIG. 2a.

This device 100 according to a first exemplary embodiment comprises a detector 120 configured to detect direction information of a pulse of a received signal 115. This received signal may be received via antenna 110, as exemplarily depicted in FIG. 1a. The device 100 further comprises a mixer 130 configured to downconvert the received signal 115,125 and a processor 140 configured to perform lightning detection based on the detected pulse direction information and the downconverted signal.

For instance, antenna 110 may represent a coil antenna, but also any other suited antenna may be used. Furthermore, antenna 110 may have a spatial directivity, and for instance, the antenna may have a differential output. For example, the antenna 110 may be part of a resonance circuit.

The received signal from antenna 110 is used by detector 120 in order to detect direction information of at least one pulse of the received signal, in accordance with step 210 of the first exemplary method depicted in FIG. 2a.

The direction of the pulse may be considered to represent the direction of the pulse's current flowing through signal line 115.

FIG. 1b depicts a schematic diagram of an exemplary pulse 160 to be detected. This pulse 160 represents an exemplary pulse received by antenna 110 and it may be caused by an electrical discharge within a cloud or by a cloud to ground lightning, for instance.

The detection of pulse direction information may be performed in different ways. For instance, a gradient detection method may be used in order detect whether a pulse starts with a positive slope or a negative slope. For example, this may be realized based on differentiating the received signal.

Or, for instance, the pulse direction information detection may be performed based on peak detection. For example, the detecting of the direction information of a pulse may comprise detecting whether a pulse of the received signal first exceeds a positive threshold level or first exceeds a negative threshold level. This exemplary pulse direction detection is shown in FIG. 1b, wherein a positive threshold level +l₁ and a negative threshold level −l₂ are used to detect whether a new received pulse 160 first exceeds the positive threshold level or first goes below the negative threshold level. In case the received pulse 160 first exceeds the positive threshold +l₁, as exemplarily depicted in FIG. 1b, indicated by reference sign 161, the pulse direction is detected to be positive. In the other case, i.e. the received pulse first goes below the negative threshold −l₂ (not depicted in FIG. 1b), the pulse direction is detected to be negative. The absolute values of the positive threshold level and the negative threshold level may be different or may have the same value.

The pulse direction information may for instance represent direct information about the direction of the detected pulse, or it may represent information which is suited to determine the direction of the detected pulse. For instance, this calculation may be performed by the processor 140 or by the detector 120 itself.

Furthermore, for instance, the peak detection may be performed by the detector 120 in the way that time stamps or other representatives of the positive threshold level trigger event and the negative threshold level trigger event, indicated by reference signs 161 and 162 in FIG. 1b, respectively, are generated and transmitted to the processor 140. For instance, said representatives of said trigger events may be coded signals indicating the respecting trigger event. Thus, based on these timestamps or the trigger representatives, i.e. the pulse direction information, and the associated positive or negative threshold, the processor 140 can determine the pulse direction of a received pulse 160.

The threshold levels at detector 120 may be configured by processor 140, e.g. by means of a separate signal line (not depicted in FIG. 1a). Accordingly, the detector 120 may be configurable. For instance, the processor 140 may adjust the threshold levels based on the downsampled received signal.

Of course, any other well-suited method may be performed to carry out the pulse direction detection of a pulse of the received signal by detector 120.

The detected pulse direction information is fed to the processor 140, for instance by means of signal line 121.

Furthermore, the received signal is fed to mixer 130 via signal line 125. The mixer 130 is configured to downconvert the received signal 125 into lower frequency ranges, as indicated by step 220 in FIG. 2a. For instance, the mixer 130 is fed by a local oscillating signal 135 having a predetermined oscillating frequency.

For example, the mixer 130 may be configured to mix the received signal down to audio frequencies. Thus, the processor 140 can operate at a low clock rate so that low power consumption and a reasonable price may be achieved.

The lightning detection performed by processor 140 is based on the downconverted received signal and the detected pulse direction, as indicated by step 230 in FIG. 2a. Based on the detected pulse direction, the direction of the lightning source with respect to the characteristics of antenna 110 can be determined.

Thus, the phase of local oscillating signal 135 must not necessarily have to be known at processor 140 in order to determine the direction of current of the received pulse, since the pulse direction is detected by means of detector 120 before the received signal is downconverted. Accordingly, the phase information of the local oscillating signal 135 is not necessary. Hence, tracking the phase of the local oscillating signal 135 is not necessary.

Furthermore, for instance, it may be assumed that negative cloud to ground lightning is more frequent than positive cloud to ground lightning. This information may be combined with the information from detector 120, so that ambiguity of the direction of the lightning source can be removed in processor 140. Furthermore, statistical information about the pulse may be extracted from the donwconverted received signal by the processor 140 in order to separate pulses generated from positive cloud to ground lightning and pulses generated from negative cloud to ground lightning. Based on this separation and the detected pulse direction, the direction of the lightning can be determined and the position may be determined by processor 140. For instance, based on the detected pulse direction information, and thus based on the pulse direction, the detected lightning can be placed in the correct part of a coordinate system.

Furthermore, for instance, the downconverted received signal may be used by the processor 140 to determine the distance of the lightning with respect to the antenna 110. For instance, an average lightning signal may be assumed to have 1/f dependence between amplitude and frequency. Processing of the gathered signals in processor 140 may be done based on the distribution of activity. For instance, the distance may be determined based on the amplitude and frequency of the lightning signal.

Thus, the processor 140 may be configured to determine the direction and the distance of the lighting based on the detected pulse direction and the downconverted received signal.

The first exemplary device 100 depicted in FIG. 1a depicts only one signal path with one antenna 110. It has to be understood, that the first exemplary device 100 can be extended with additional signals paths, wherein each additional signal path may comprise an own detector configured to detect direction information of a pulse of the respective received signal and an own mixer configured to downconvert the respective received signal.

Furthermore, the detector 120 may be used to switch on the processor 140 after a pulse has been detected. Thus, the detector 120 may be used to wake up parts of the device 100 in case a pulse of a lightning is detected. If no pulse is detected for a predetermined time period, those parts may be switched off in order to save power.

The explanations stated above with respect to the first exemplary device 100 and its components also holds for the following exemplary embodiments and the respective components of these embodiments.

FIG. 2b depicts a schematic block diagram of a second exemplary embodiment of a device 200.

This device 200 is based on the exemplary device 100 according to the first exemplary embodiment depicted in FIG. 1a and comprises two signal paths, wherein the first signal path comprises a first antenna 110, a first detector 120 and a first mixer 130, and wherein the second signal path comprises a second antenna 110′, a second detector 120′ and a second mixer 130′.

The first antenna 110 and the second antenna 110′ may represent two physical orthogonal antennas, or may represent two substantially orthogonal antennas, or may represent two antennas having different spatial directivity. For instance, the first and second antenna 110,110′ may represent coil antennas, as exemplarily depicted in FIG. 2b, but any other suited antenna having a directional receiving pattern may be used for antennas 110,110′.

Each of the detectors 120,120′ is configured to detect a direction of a pulse of the respective received signal. For instance, this detection may be performed as described with respect to detector 120 of the first exemplary embodiment depicted in FIG. 1a.

The first mixer 130 is provided with a first local oscillating signal 135 and the second mixer 130′ is provided with a second local oscillating signal 135′. Both first and second local oscillating signals may have the same oscillating frequencies, but may have different phases. For instance, the phases of the first and second local oscillating signals may be in opposing phase or at least substantially in opposing phase shifted to each other.

Lightning signals with significant amplitude may exist up to several giga hertz. Due to the different phases of the local oscillating signals it may be possible to detect even very short lightning bursts having high frequencies, wherein these bursts may ride on the top of a lower frequency lightning signal. For instance, when these bursts occur at a time when the absolute value of the first local oscillating signal waveform is small they can be lost in the first signal path, but due to a phase shifted second local oscillating signal the absolute value of the second local oscillating signal is higher and these bursts can be processed via the second signal path and the processor 140′. Thus, even transients can be detected reliably due to the different phases of the local oscillating signals 135 and 135′.

For instance, a single local oscillator (not depicted in FIG. 2b) can be used to generate the first and second oscillating signals, wherein the first mixer 130′ may be directly fed with the local oscillating signal generated by the local oscillator, and wherein a phase shifter is added before the second mixer 130′.

Thus, when antennas 110 and 110′ have overlapping directions the device 200 can be used to get an indication of these short bursts from at least one of the input paths. Hence, a subset of lightning phenomena emit Radio Frequency (RF) radiation in short bursts can be used for lightning detection.

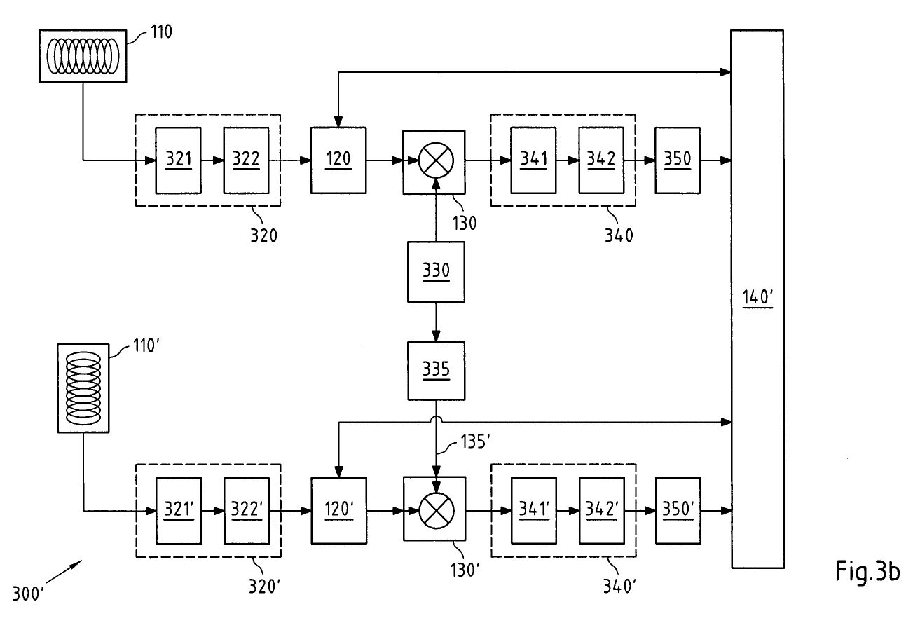

FIG. 4 exemplarily depicts schematic direction patterns of two orthogonal antennas, which may for instance be used for antennas 110 and 110′. The first pattern, which may be associated with the exemplary coil antenna 110 of the second exemplary embodiment, is indicated by reference sign 410, and the second pattern, which may be associated with the exemplary coil antenna 110′, is indicated by reference sign 420. It can be seen, that both patterns 410 and 420 have overlapping regions.

Due to the two signal paths of device 200 of the second exemplary embodiment, the processor 140′ can calculate the distance and the angle in a coordinate system's quadrant of a lightning event with respect to antennas 110 and 110′, and, further, due to the detected pulse direction information, the processor 140′ can determine in which quadrant of the coordinate system the lightning signal emanates from. Thus, the device 200 is configured to detect the lightning position.

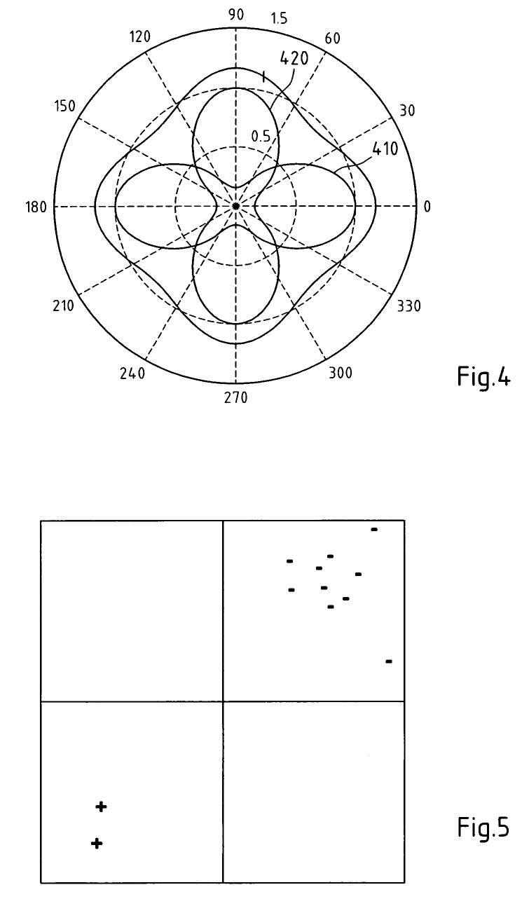

Hence, the device 200 may be configured to give a mirror image of a storm based on detected lightnings, as exemplarily depicted in FIG. 5. These mirror images can be recognized especially as the storm is normally moving in the wind. For instance, the recognition may be supported by using features of the downconverted signals in order to separate positive and negative cloud to ground lightning, as explained with respect to the first exemplary embodiment.

For instance, the polarity of a lightning strike can either be determined from the actual signal or it can be determined based on the locations of the strikes. In FIG. 5 the plus signs in the lower left hand actually belong to the same quadrant as the negative signs but due to the assumption of negative strikes they have been misplaced. Because the negatives usually far outnumber the positives this mirror image can usually (depending on the storm size and location) be identified and after that the strikes (shown as positive in FIG. 5) can be correctly located among the negative ones.

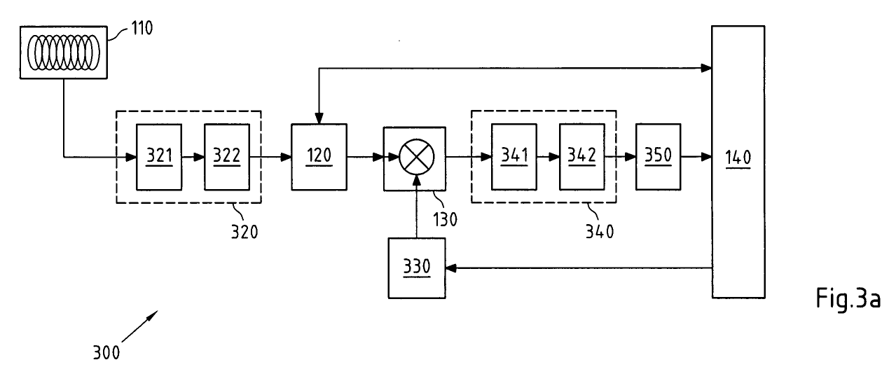

FIG. 3a depicts a schematic block diagram of a third exemplary embodiment of a device 300.

This device 300 according to the third exemplary embodiment is based on device 100 of the first exemplary embodiment.

Device 300 comprises a unit 320 configured to process the received signal from antenna 110. For instance, this unit 320 may comprise a band limiting filter 321 and/or an amplifier 322.

Furthermore, device 300 comprises a signal processing unit 340 between the mixer 130 and the processor 140. This signal processing unit 340 may comprise a filter 341 and, optional, an amplifier 342. The device 300 further comprises an analog-to-digital converter (ADC) 350.

The filter 341 may represent a low-pass filter. For instance, the filter 341 may fulfill the nyquist criterion with respect to the sampling rate of the ADC 350. Thus, signals above the nyquist frequency can be removed.

Furthermore, for instance, as another example, the filter 341 may be a low-pass filter having a wider frequency range than the nyquist frequency. Thus, also energy of higher frequencies can be used for lightning detection in order to measure the distance by processor 140, since measuring the distance may likely concentrate on activity and not on specific signal shape. Further, letting higher frequencies alias makes the signal stronger. Thus, this exemplary third embodiment may be used to reduce the bandwidth in the digital part, whereby the overall system performance, e.g. smaller power consumption and complexity, may be increased.

Hence, a narrowband receiver can be used for lightning detecting, wherein this narrowband receiver may operate at a single frequency.

Furthermore, the local oscillator 330 and/or the mixer 130 may be configured to be switched on and off. Thus, the mixer 130 can be shut down in order to save power while the direction of lightnings can still be tracked by means of detector 120. Thus, for instance, the direction of a storm can be tracked due to pulse detector 120 during this power save mode.

FIG. 3b depicts a schematic block diagram of a fourth exemplary embodiment of a device 300′ according to the present invention.

This device 300′ may be considered to represent a combination of the device 200 according to the second exemplary embodiment and the device 300 according to the third exemplary embodiment. Thus, the explanations concerning the second and third exemplary embodiment also hold for this fourth exemplary embodiment.

The device comprises a phase shifter 335 in order to shift the phase of the local oscillator's signal. Thus, the second mixer 130′ is provided with a phase shifted local oscillating signal compared to the local oscillating signal of the first mixer 130. For instance, the phase shift may represent 900.

Each of the first and second signal path comprises a unit 320 and 320′ in order to process the received signal from the respective antenna 110,110′, as explained above with respect to unit 320 of the third exemplary embodiment. For instance, filters 321 and 321′ may operate on a large bandwidth, but this bandwidth may be chosen so that no spurious signals outside the bandwidth of interest are detected.

Furthermore, each of the first and second signal path comprises a signal processing unit 340 and 340′, as explained above with respect to signal processing unit 340 of the third exemplary embodiment, i.e. each of the signal paths may comprise a filter 341,341′ and an amplifier 342,342′. Furthermore, each of the signal paths comprises an ADC converter 350, 350′.

Due to the use of two channels, the position of the lightnings can be determined, wherein the pulse detectors 120 and 120′ can be used to determine the direction and the downsampled received signals can be used to measure the distance, as explained before.

It has to be noted that while FIGS. 2b and 3b each has two channels an extension to three or more channels can also be applied for a device. For instance, assuming a three channel device, a further phase shifter (not depicted in FIG. 3b) may be added and the third antenna may be physically orthogonal or at least substantially orthogonal to the other two antennas 110 and 110′. For instance, the use of three channels makes the detection independent of the orientation of the host device on the condition that the orientation is known. The orientation may be known if the host device for example has an accelerometer that may give this information.

Thus, the position of the lightning source can be detected by means of the pulse detectors 120 and 120′ without having knowledge about the phases of the local oscillating signals 135 and 135′.

It is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. Said computer software may be stored in a variety of storage media of electric, magnetic, electromagnetic or optic type and may be read and executed by a processor, such as for instance a microprocessor. To this end, said processor and said storage medium may be coupled to interchange information, or the storage medium may be included in the processor.

The invention has been described above by means of exemplary embodiments. It should be noted that there are alternative ways and variations which are obvious to a skilled person in the art and can be implemented without deviating from the scope and spirit of the appended claims. In particular, the present invention is not limited to two antennas in order to perform lightning detection, but also more antennas may be used for the lightning detection.

What is claimed is:

1. A method, comprising:
detecting direction information of at least one pulse of at least one received signal,
downconverting the at least one received signal,and
performing lightning detection based on the at least one detected pulse direction information and the at least one downconverted signal.

2. The method according to claim 1, wherein the detecting of direction information of at least one pulse of at least one received signal is based on a signal peak detection.

3. The method according to claim 2, wherein the detecting direction information of at least one pulse comprises at least one of:
detecting whether the received signal is higher than a positive threshold level, and
detecting whether the received signal is less than a negative threshold level.

4. The method according to claim 3, comprising adjusting at least one of said threshold levels based on the at least one downconverted received signal.

5. The method according to claim 1, wherein said lightning detection is triggered when said at least one pulse of the at least one received signal is detected.

6. The method according to claim 1, comprising low-pass filtering and analog-to-digital converting of each of the at least one downconverted signal.

7. The method according to claim 6, wherein said low-pass filtering has a cut-off frequency which is substantially higher than the nyquist frequency associated with the analog-to-digital converting.

8. The method according to claim 1, wherein said at least one received signal comprises at least two received signals, and wherein each of said at least two received signals is associated with a different antenna.

9. The method according to claim 8, wherein each of said at least two received signals is associated with a separate oscillating signal and said downconverting comprises mixing each of the at least two received signals with the associated oscillating signal, and wherein each of said at least two oscillating signals has a different phase.

10. The method according to claim 1, wherein said lightning detection comprises detecting the direction of a lightning event based on the at least one detected pulse direction information.

11. The method according to claim 10, wherein each of said at least one received signal is associated with a different antenna, each of this at least one antenna having a directional axis and a first lobe extending to one side of the directional axis and a second lobe extending to an opposite side of the directional axis, and wherein the detected pulse direction information associated with the received signal from one of said at least one antenna indicates whether the signal is received from the first lobe or the second lobe of this antenna.

12. The method according to claim 10, wherein said detecting the direction of a lightning event based on the at least one detected pulse direction information is performed based on statistical information that positive cloud to ground lightning is less frequent than negative cloud to ground lightning.

13. The method according to claim 1, wherein said lightning detection comprises measuring the distance of a lightning event based on the at least one downconverted received signal.

14. The method according to claim 13, wherein each of said at least one received signal is associated with a different antenna, each of this at least one antenna having a directional axis, wherein said measuring the distance of a lightning event comprises determining the distance in at least one directional axis of the at least one antenna, wherein the distance in an directional axis of an antenna is determined based on the frequency and amplitude of the downconverted received signal which is associated with this antenna.

15. A device, comprising
at least one detector configured to detect direction information of at least one pulse of at least one received signal;
at least one mixer configured to downconvert the at least one received signal; and
a processor configured to perform lightning detection based on the at least one detected pulse direction information and the at least one downconverted signal.

16. The device according to claim 15, wherein the detecting of the direction information of at least one pulse of at least one received signal is based on a signal peak detection.

17. The device according to claim 16, wherein the detector is configured to perform detecting the direction information of at least one pulse by at least one of:
detecting whether the received signal is higher than a positive threshold level, and
detecting whether the received signal is less than a negative threshold level.

18. The device according to claim 17, wherein the detector is configurable and the processor is configured to adjust at least one of said threshold levels at the detector based on the at least one downconverted received signal.

19. The device according to claim 15, wherein the processor is configured to be switched on and off, and wherein the detector is configured to switch on the processor after a pulse of at least one received signal is detected.

20. The device according to claim 15, wherein each of said at least one mixer is associated with a low-pass filter and an analog-to-digital converter configured to perform low-pass filtering and analogue-to digital conversion of the respective downconverted received signal.

21. The device according to claim 20, wherein said low-pass filter has a cut-off frequency which is substantially higher than the nyquist frequency associated with the analog-to-digital converter.

22. The device according to claim 15, wherein said at least one detector comprises at least two detectors, and wherein each of said at least two detectors is associated with a received signal which is received from a separate antenna.

23. The device according to claim 22, wherein said at least one mixer comprises at least two mixers, and wherein each of said at least two received signals is associated with one mixer of said at least two mixers, and wherein each of said at least two mixers is associated with a separate oscillating signal in order to downconvert the respective received signal, and wherein each of said at least two oscillating signals has a different phase.

24. The device according to claim 15, wherein said lightning detection comprises detecting the direction of a lightning event based on the at least one detected pulse direction information.

25. The device according to claim 24, wherein each of said at least one received signal is associated with a different antenna, each of this at least one antenna having a directional axis and a first lobe extending to one side of the directional axis and a second lobe extending to an opposite side of the directional axis, and wherein the detected pulse direction information associated with the received signal from one of said at least one antenna indicates whether the signal is received from the first lobe or the second lobe of this antenna.

26. The device according to claim 24, wherein said detecting the direction of a lightning event based on the at least one detected pulse direction information is performed based on statistical information that positive cloud to ground lightning is less frequent than negative cloud to ground lightning.

27. The device according to claim 15, wherein said lightning detection comprises measuring the distance of a lightning event based on the at least one downconverted received signal.

28. The device according to claim 27, wherein each of said at least one received signal is associated with a different antenna, each of this at least one antenna having a directional axis, wherein said measuring the distance of a lightning event comprises determining the distance in at least one directional axis of the at least one antenna, wherein the distance in an directional axis of an antenna is determined based on the frequency and amplitude of the downconverted received signal which is associated with this antenna.

29. A computer-readable storage medium encoded with instructions that, when executed by a computer, perform:
detecting the direction of at least one pulse of at least one received signal;
downconverting the at least one received signal;
performing lightning detection based on the at least one detected pulse direction and the at least one downconverted signal.

30. The computer-readable storage medium according to claim 29, wherein the detecting of the direction of a pulse is based on a signal peak detection.

31. A system, comprising:
At least one antenna configured to receive at least one signal,
a device according to claim 15, and
a display configured to display a detected lightning.

32. The system according to claim 31, comprising at least two antennas, wherein each of said at least two antennas is substantially orthogonal to the remaining antennas.

33. A device, comprising
at least one detecting means for detecting direction information of at least one pulse of at least one received signal;
at least one mixing means for downconverting the at least one received signal; and
a processor means for performing lightning detection based on the at least one detected pulse direction information and the at least one downconverted signal.

34. The device according to claim 33, wherein said at least one detecting means comprises at least two detecting means, and wherein each of said at least two detecting means is associated with a received signal which is received from a separate antenna means.
